(19) United States
(12) Patent Application Publication
(10) Pub. No.: US 2004/0011900 A1
(43) Pub. Date: Jan. 22, 2004

(54) Fuel injector assembly

(76) Inventors: Jens Gebhardt, Columbia, SC (US); Martin Luedicke, Columbia, SC (US); Bernd Niethammer, Blythewood, SC (US)

Correspondence Address: McGuire Woods LLP, Tysons Corner, 1750 Tysons Boulevard, Suite 1800, McLean, VA, 22102-4215, US

(21) Appl. No.: 10/396,364

(22) Filed: Mar. 26, 2003

Related U.S. Application Data
(60) Provisional application No. 60/382,044, filed on May 22, 2002.

(51) Int. Cl. B05B 1/30

(52) U.S. Cl. 239/585.1

(57) ABSTRACT

An oil activated fuel injector includes a control valve body with end cap solenoids and a slidably mounted spool. A minimized contact surface area exists between the spool and one of the first and second solenoid coils providing a minimized ratio of surface area versus boundary line of a contact surface to prevent a change in latching effects. The minimized surface may be on the end of the spool or one or both of the end caps. The minimized surface area may be a raised portion of different dimensions.

### CROSS REFERENCE TO RELATED APPLICATION

This application claims the benefit of U.S. Provisional Patent Application No. 60/382,044, filed on May 22, 2002, which is hereby incorporated by reference for all purposes as if fully set forth herein.

### BACKGROUND OF THE INVENTION

1. Field of the Invention

The present invention generally relates to a fuel injector and, more particularly, to an optimized geometry that minimizes surface area between a spool and solenoids of a control valve for reducing or preventing a change in a latching effect.

2. Background Description

There are many types of fuel injectors designed to inject fuel into a combustion chamber of an engine. For example, fuel injectors may be mechanically, electrically or hydraulically controlled in order to inject fuel into the combustion chamber of the engine. In the hydraulically actuated systems, a control valve body may be provided with two, three or four way valve systems, each having grooves or orifices which allow fluid communication between working ports, high pressure ports and venting ports of the control valve body of the fuel injector and the inlet area. The working fluid is typically engine oil or other types of suitable hydraulic fluid capable of providing a pressure within the fuel injector in order to begin the process of injecting fuel into the combustion chamber.

In current designs, a driver will deliver a current or voltage to an open side of an open coil solenoid. The magnetic force generated in the open coil solenoid will shift a spool into the open position so as to align grooves or orifices (hereinafter referred to as “grooves”) of the control valve body and the spool. The alignment of the grooves permits the working fluid to flow into an intensifier chamber from an inlet portion of the control valve body (via working ports). The high-pressure working fluid then acts on an intensifier piston to compress an intensifier spring and hence compress fuel located within a high-pressure plunger chamber. As the pressure in the high-pressure plunger chamber increases, the fuel pressure will begin to rise above a needle check valve opening pressure. At the prescribed fuel pressure level, the needle check valve will shift against the needle spring and open the injection holes in a nozzle tip. The fuel will then be injected into the combustion chamber of the engine.

However, in such conventional systems, over time changes in latching effects between the spool and end caps or solenoids retard the injection start due to a delayed motion of the spool in the opening direction. For example, the spool may temporarily latch to a solenoid endcap, which delays the spool from moving. In this manner response times between the injection cycles may be slowed thus decreasing the efficiency of the fuel injector. It has been found that fuel injectors have experienced low fuel delivery and/or erratic injector behavior, typically after various run times, for example, 2 to 3000 hours. It has been further found that this reduced efficiency has increased at higher rail pressures. Time delays regarding first injection events at the pulse width map are also frequently observed. This reduction of the fuel quantity may also be accompanied by higher shot to shot variation. Also, fuel deterioration is potentially caused by small changes of about a 0.5 μm wear on the surfaces between the spool and the end caps in combination with oil present in the end caps.

The present invention is directed to overcoming one or more of the problems as set forth above.

### SUMMARY OF THE INVENTION

Accordingly, the present invention is directed to a fuel injector assembly that substantially obviates one or more of the problems due to limitations and disadvantages of the related art.

In a first aspect of the present invention, a hydraulically controlled valve control body includes a control body. A first solenoid coil is positioned at a first end of the control body and a second solenoid coil is positioned at an opposing second end of the control body. A spool is positioned within the control body between the first and second solenoid coils. A minimized contact surface area contacting the spool and one of the first and second solenoid coils prevents changes in latching effects.

In embodiments, the minimized surface area may be a raised portion on either or both ends of the spool or on either or both facing surfaces of the solenoids. The raised surface may be many different configurations such as cross hatching, inner and/or outer rings, one or more rectangles or other raised portions. The minimized contact surface area provides a minimized ratio of surface area versus boundary line of a contact surface, and may provide drainage of an oil film between the spool and one of the first or second solenoid coils.

In another aspect of the present invention, a replacement kit for a hydraulically controlled valve control body is provided. The replacement kit includes a spool or an end cap having a minimized contact surface area. The reassembled valve control body using the kit of the present invention includes the minimized surface area positioned between the spool and the end cap for reducing changes in latching effects between the spool and the end caps thereby minimizing spool delay.

In another aspect of the present invention, an injector is provided. The injector includes a body control valve having an inlet port and working ports. A first and second solenoid coil is positioned at opposing ends of the body control valve. A slidably mounted spool is arranged substantially between the first and second solenoid coils. A minimized contact surface area exists between the spool and one of the first and second solenoid coils to prevent changes in latching between the spool and one of the first and second solenoid coil during an opening or closing stage. An intensifier chamber having a piston and plunger assembly is in fluid communication with the working ports. A high pressure fuel chamber arranged below a portion of the plunger provides for an increased fuel pressure. A needle chamber having a needle is responsive to the increased fuel pressure created in the high pressure fuel chamber.

In yet another aspect of the invention, a valve control body includes a control body and first and second solenoid coils positioned at ends of the control body. A spool is positioned within the control body between the open and closed solenoid coils. A means is provided for preventing changes in latching effects between a contact surface area between the spool and one of the first and second solenoid coils.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 a shows a cross sectional view of a control valve body of the present invention;

FIG. 1b shows an exploded view of FIG. 1a inside line A to A′ according to the present invention;

FIG. 2 shows a minimizing surface area according to an embodiment of the present invention;

FIG. 3 shows a side view of a chamfered edge portion for minimizing surface area according to another embodiment of the present invention;

FIG. 4a shows a top view of a two raised portion for minimizing surface area according to another embodiment of the present invention;

FIG. 4b shows a cross sectional view of FIG. 4a along line B to B′;

FIG. 5a shows a top view of a two raised portion for minimizing surface area according to another embodiment of the present invention;

FIG. 5b shows a side view of FIG. 5a;

FIG. 5c shows a top view of a raised portion for minimizing surface area according to another embodiment of the present invention;

FIG. 5d shows a side view of FIG. 5c;

FIG. 6a shows a top view of a raised portion for minimizing surface area according to another embodiment of the present invention;

FIG. 6b shows a cross sectional view of FIG. 6a along line C to C′;

FIGS. 7a and 7b show graphs illustrating data according to the present invention; and

FIG. 8 shows a cross sectional view of a fuel injector assembly according to the present invention.

### DETAILED DESCRIPTION OF A PREFERRED EMBODIMENT OF THE INVENTION

The present invention is directed to an oil activated electronically, mechanically or hydraulically controlled fuel injector and more particularly to a spool or solenoid end cap which minimizes changes in latching effects, particularly hydraulic latching effects, of the spool during activation or deactivation of the open or closed solenoids of the fuel injector. After careful investigation, it has been found that surface smoothness and/or large contact surfaces between the spool and end caps in conjunction with oil film are major contributors to the latching problem. By way of example, larger contact surfaces may result in a vacuum effect which, in part, may contribute to the change in the latching effect. The present invention prevents or minimizes a retarded start of the injection due to a delayed motion of the spool (i.e., latching) in an opening or closing direction. In embodiments, this is accomplished by using an optimized geometry that minimizes the surface area of a contact portion between the spool and one or both of the solenoid end caps. It should be understood that the present invention is directed to eliminating, reducing or preventing the changes in hydraulic latching effects; however, the present invention may equally relate to magnetic latching effects.

Embodiments of the Oil Activated Fuel Injector of the Present Invention

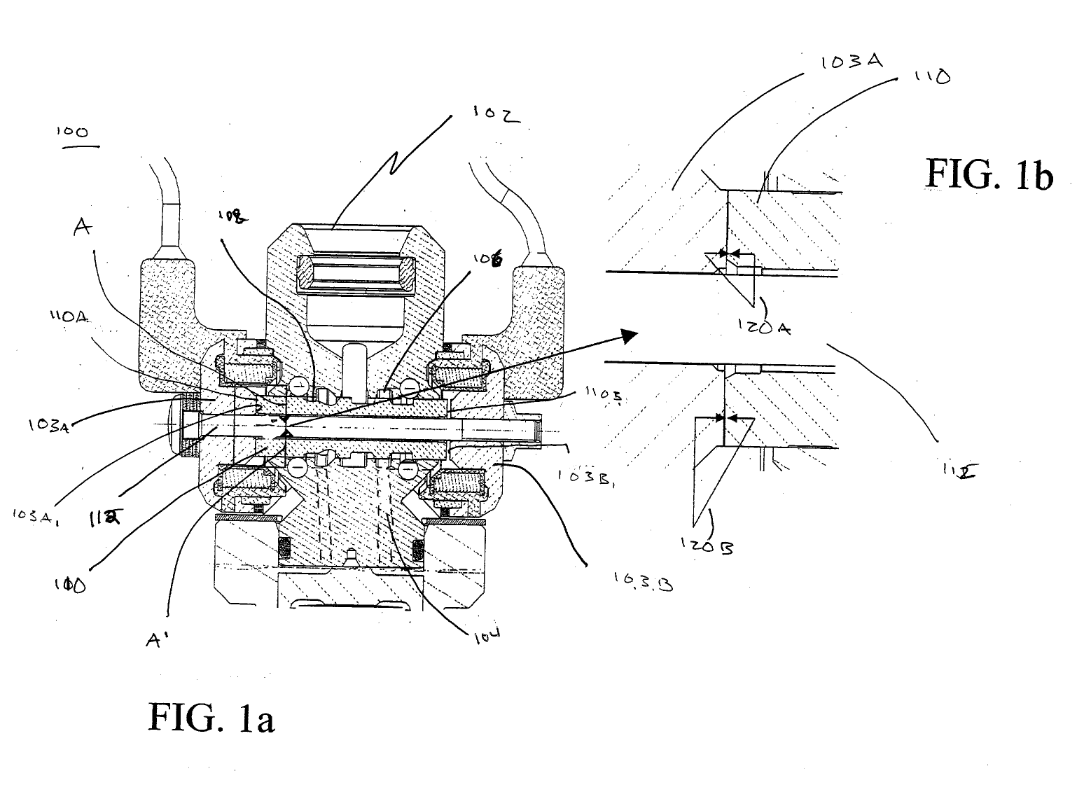

Referring now to FIG. 1a, the control valve body is generally depicted as reference numeral 100. The control valve body 100 includes an inlet area 102, which is in fluid communication with working ports 104. At least one groove or orifice (hereinafter referred to as grooves) 106 is positioned between and in fluid communication with the inlet area 102 and the working ports 104. A spool 110 having at least one groove or orifice (hereinafter referred to as grooves) 108 is slidably mounted within the control valve body 100. A bolt 112 is arranged through the spool 110 for slidably mounting the spool 110 to the control valve body 100. An open coil assembly 103A and a closed coil assembly 103B, both housed within respective solenoid end cap assemblies, are positioned on opposing sides of the spool 110. The coil assemblies 103A and 103B include a first solenoid contact surface 103A₁ facing a first spool contact surface 110A and second solenoid contact surface 103B₁ facing a second spool contact surface 110B.

In the embodiments of the invention, at least one of the contact surfaces 110A, 110B, 103A₁ or 103B₁ has a minimized surface area to prevent changes in the latching effects. This minimized surface area can be any combination of the contact surfaces, for example, a minimized contact surface 110A and 103B₁. In embodiments, only one of the facing surfaces has a minimized contact surface area; however, it is contemplated that both facing surfaces may include a combination of minimized contact surface areas. The surface area is minimized in order to reduce changes in latching effects between the spool and the respective solenoid contact surfaces. This minimized surface area may assist in the drainage of oil between the contact surfaces, thereby preventing an oil film from forming therebetween.

FIG. 1b shows an exploded view of FIG. 1a inside line A to A′ according to the present invention. Referring to FIG. 1b, reference number 120A generally represents a contact area of the first spool contact surface 110A and a portion of the first solenoid contact surface 103A₁. Reference number 120B generally represents a non-contact area of the spool and end cap, which may include, in embodiments, the first solenoid contact surface 103A₁ and the spool contact surface 110A. In this manner the present invention provides for a minimized surface area between the spool and the end cap. This minimized surface area may be formed, in embodiments, by at least one raised portion on any of the contact surfaces. This raised portion contributes to a non-contact area (e.g., a gap) between the spool 110 and the end cap. In one embodiment, for example, this gap may be approximately 30 μm. By providing this minimized contact area, the change in the latching effect can be minimized or eliminated by reducing, for example, an oil film between the spool and end cap, itself, or a vacuum or a magnetic adhesion. This is especially useful, but not limited, to the open side end cap.

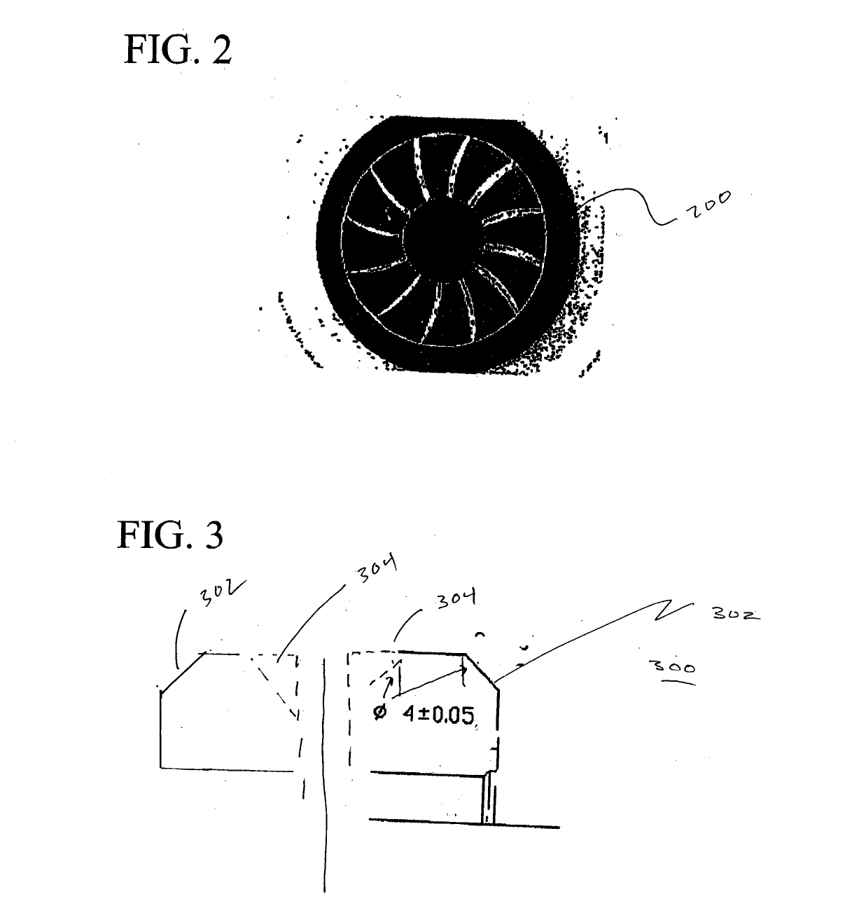

FIG. 2 shows an embodiment of the present invention. In this embodiment, the contact surfaces 110A and/or 110B at the ends of the spool 110 may be designed with a changed surface structure 200 (e.g., a cross hatch pattern). The cross hatch may be in the form of a star pattern, helical pattern or other pattern for minimizing the surface area and thereby reducing, preventing or eliminating the change in the latching effects between the spool and one of the end caps. This cross hatch or other pattern may be etched or milled or other type of pattern causing recessed portions 200A and raised portions 220B. The changed structure may also be a roughened surface (i.e., surface optimization/minimization at the microscopic scale). The raised portions 200B act as the minimized contact surface area or contact portions between the solenoid and either of the end caps. The recessed portions 200A, on the other hand, form gaps designed to provide for oil drain paths. The structure according to this embodiment may be applied to any combination of the contact surfaces. That is, the structure may be applied to any combination of the spools contact surfaces 110A and/or 110B and/or the solenoid contact surfaces 103A₁ and/or 103B₁. It should be understood that quality and structure of the contact and non-contact surface have a significant influence on the fuel decay.

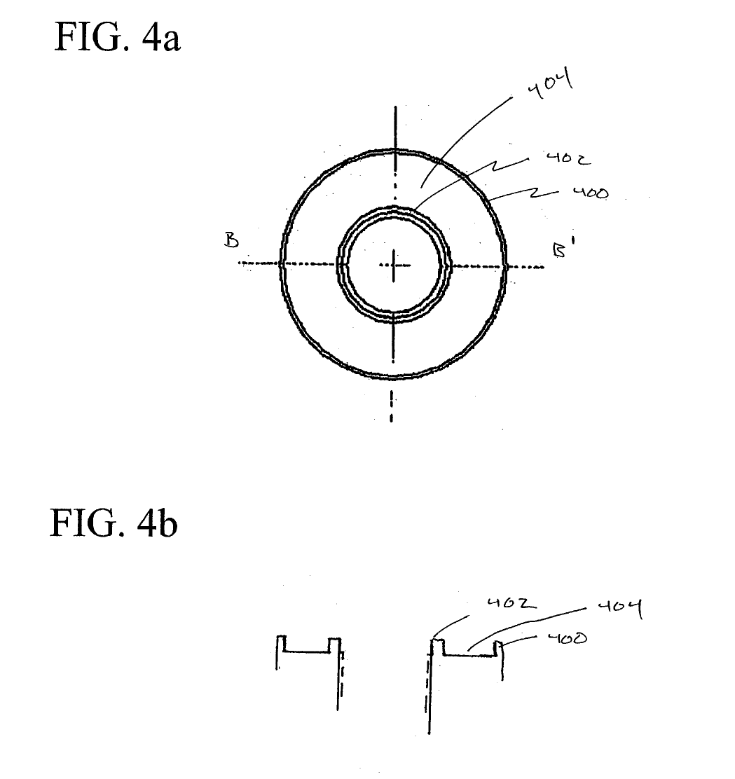

FIG. 3 shows another embodiment of the present invention. In this embodiment, the contact surfaces 110A and/or 110B may be optimized with a turned angle geometry represented generally by reference numeral 300 for minimizing the surface area and thereby substantially obviating the change in latching effects. The turned angle geometry may be in the form of a chamfered edge 302. In one exemplary illustration, the chamfered edge 302 may be applied to the edge 302 and/or 304 of the contact surfaces 110A and/or 110B and/or contact surfaces 302A₁ and/or 302B₁. In the embodiments, this chamfered edge may be at a 4° angle with ±0.05° deviation as shown in FIG. 3. The geometry, of course, can vary with any application of the present invention. Also, the structure may be applied to any combination of the outside and inside edges 302, 304, respectively. For example, the structure 302 may be only applied to the inside edge as represented by reference numeral 304. In embodiments, the chamfer is manufactured using either a grinding or turning method, which provides a rough surface on the non-contact area. This, again, may assist in reducing, preventing or eliminating the change in the latching effects.

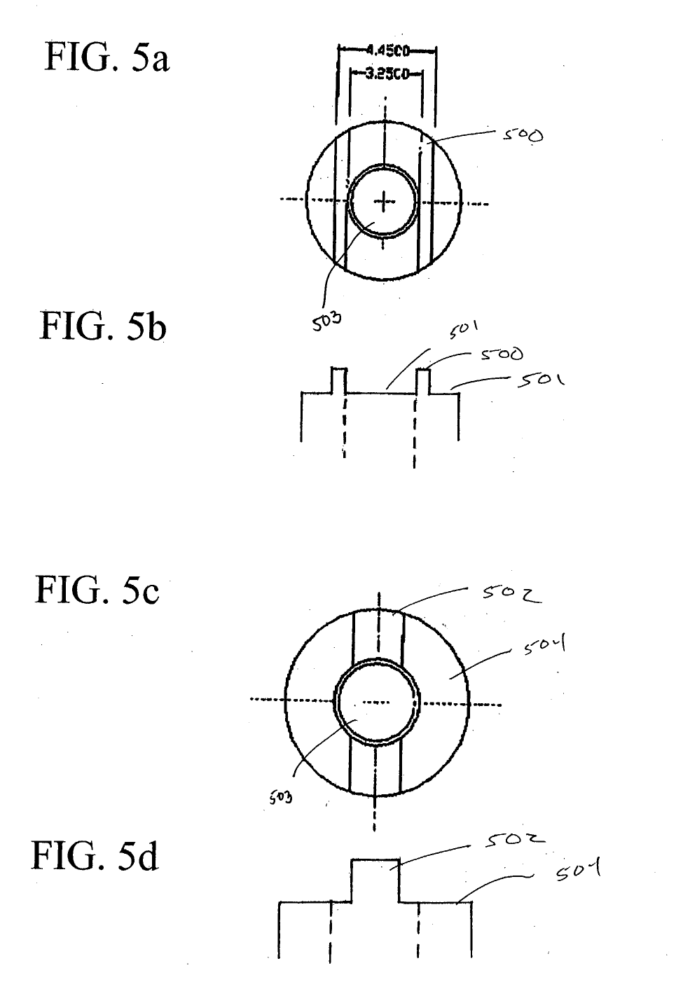

FIG. 4a shows a top view of two raised portions for minimizing surface area according to another embodiment of the present invention. FIG. 4b shows an exploded cross sectional view of FIG. 4a along line B to B′ of the two raised portions. Referring to FIGS. 4a and 4b, the contact surfaces 110A and/or 110B may have two raised portions such as an inner ring 402 and an outer ring 404 raised along a surface of the end of the spool. The raised ring may be termed as “lips”. In one exemplary illustration, the outer ring 402 represents a first raised ring having an inside diameter (ID) and the inner ring 400 represents a second raised ring having an outside diameter (OD). Portion 404 between the first and second ring is a lowered or recessed surface, such that, the first ring 402 and second ring 404 comprise the contact surface with the solenoid contact surfaces. The configuration of FIGS. 4a and 4b may equally be applied to any combination of the contact surfaces 110A and/or 110B and the contact surfaces 103A₁ and/or 103B₁. Additionally, the first ring 402 and second ring 404 is not required to have a continuously raised portion; that is, the raised rings 402 and 404 may have a stepped pattern or other disjointed pattern (i.e., non-contiguous raised portions).

Still referring to FIGS. 4a and 4b, those of ordinary skill in the art should understand that hydraulic adhesion is dependent on the ratio of the surface area versus boundary line of the surface. The hydraulic adhesion may, in turn, contribute to the latching effect. Thus, by providing the outer and inner ring design of FIGS. 4a and 4b, a ratio at a given geometry is minimized thus reducing, preventing or eliminating the change in the latching effect. That is, the hydraulic adhesion or vacuum effect is minimized due to a minimized surface area between the outer and inner ring and other contact surface. As discussed with reference to other embodiments, the ratio may vary depending on the application of use. This is applicable for all embodiments.

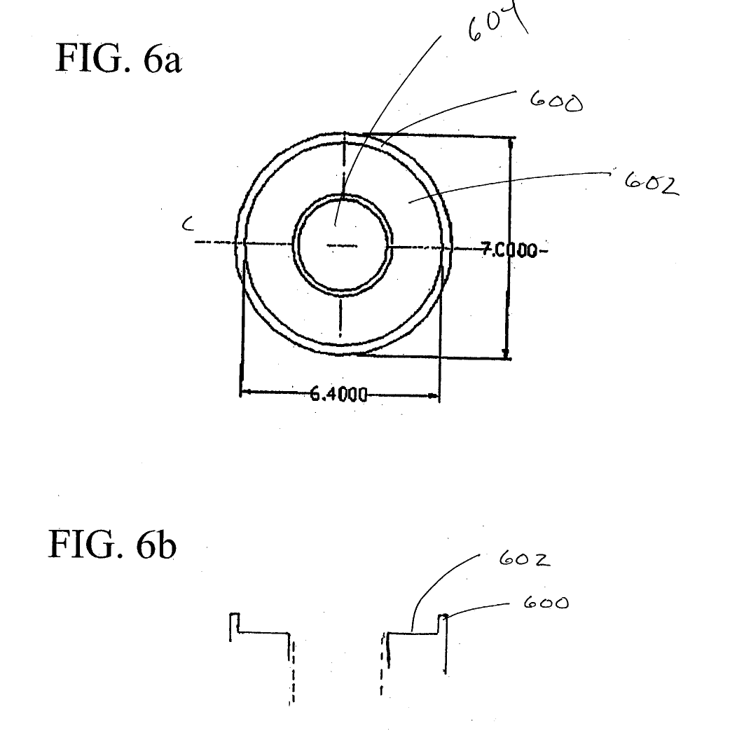

FIG. 5a shows a top view of a two raised portion for minimizing surface area according to another embodiment of the present invention. FIG. 5b shows a side view of FIG. 5a. Referring to FIGS. 5a and 5b collectively, the contact surfaces 110A and/or 110B may be two projections 500 extending substantially across a circumference of the spool on either side of the hollow section 503. The projections or raised portions 500 are provided to minimize the surface area and thereby reduce, prevent or eliminate the change in the latching effects. The projections 500 are raised above the lowered or recessed surface 501. Accordingly, the projections 500 provide for a contact surface with the surfaces of the end cap. The configuration of this embodiment may equally be applied to any combination of the contact surfaces 110A and/or 110B and the solenoid contact surfaces 103A₁ and/or 103B₁. Additionally, the projections 500 are not required to have to be continuously raised, but may be a stepped pattern or other disjointed configuration. (i.e., non-contiguous raised wall portions) It should be understood that the configuration of 5a-5b may be inverted such that portion 501 is the raised portion and portion 500 is the recessed portion.

Still referring to FIGS. 5a and 5b, each of the projections 500 have a width of approximately 1.2000 mm thus providing a minimized ratio of the surface area versus boundary line of the surface (much like that of the embodiment of FIGS. 4a and 4b). This width or surface area ratio, of course, may vary depending on the specific application of the injector. For example, a diesel fuel injector may have a larger width or surface area ratio than a gasoline fuel injector due to the size of the injector required for the engine. It should further be understood that approximately the same ratio as that of the embodiment of FIGS. 4a and 4b is contemplated by the present invention, but may vary accordingly. Additionally, the wear on the contact area of the embodiment of FIGS. 5a and 5b is minimized due the rotation of the spool; that is, the rotation of the spool minimizes the contact between any one area or point between the spool and either of the end caps. It should now be understood that by eliminating or reducing wear on the surfaces will equate to no change in the magnetic or hydraulic latching due to the fact that the gap between the surfaces and the quality of the surfaces does not change over time. This reduced wear will positively influence the fuel decay.

FIG. 5c shows a top view of a raised portion for minimizing surface area according to another embodiment of the present invention. FIG. 5d shows a side view of FIG. 5d. Referring to FIGS. 5c and 5d collectively, the contact surfaces 110A and/or 110B may have a projection 502 extending substantially across a circumference of the spool on either side of the hollow section 503. The projection 502 is provided to minimize the surface area and thereby reducing, preventing or eliminating the change in the latching effects. The projection 502 is raised above the lowered or recessed surface 504. Accordingly, the projection 502 provides for a contact surface with the surfaces of the end cap. The configuration of this embodiment may be applied to any combination of the contact surfaces 110A and/or 110B and the solenoid contact surfaces 103A₁ and/or 103B₁. Additionally, the projection 502 is not required to have to be continuously raised, but may be a stepped pattern or other disjointed configuration. (i.e., non-contiguous raised portion). It should be understood that the configuration of 5c-5d may inverted such that portion 504 is raised and portion 502 is a lowered portion.

Similar to previous embodiments, the ratio of the surface area versus boundary line of the surface is minimized. The surface area of the single projection 502 should, in embodiments, be equal to the surface area of the two projections 500 of FIGS. 5a and 5b. This surface area, of course, may also vary depending on the specific application of the injector. Additionally, the wear on the contact area of the embodiment of FIGS. 5c and 5d is also minimized due the rotation of the spool. This reduced wear will positively influence the fuel decay.

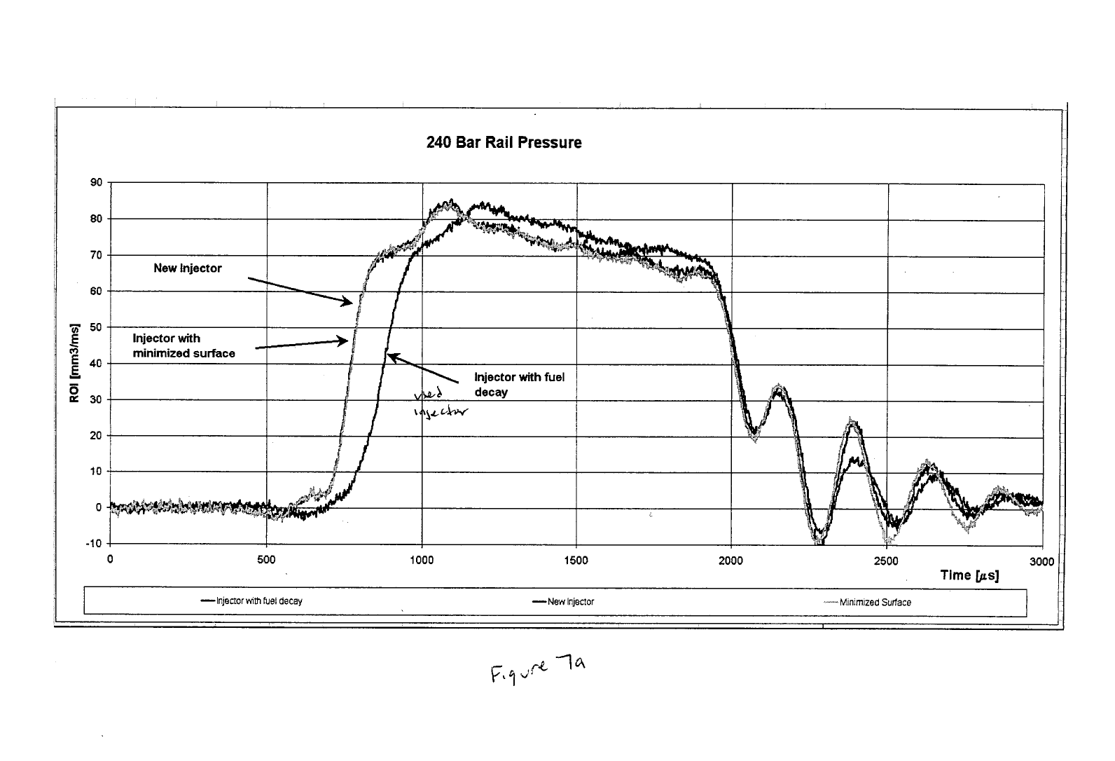

FIG. 6a shows a top view of a raised portion for minimizing surface area according to another embodiment of the present invention. FIG. 6b shows a cross sectional view of FIG. 6a along line C to C′ of the raised portion for minimizing surface area according to another embodiment of the present invention. Referring to FIGS. 6a and 6b, the contact surfaces 110A and/or 110B at the end of the spool may have the minimized surface area portion, such as a raised ring along a surface of at the end of the spool. The raised ring may be termed as “lips”. In one exemplary illustration, the raised contact surface area is depicted as an outer ring 600 having an inside diameter (ID) of 6.4 mm and an outer diameter of 7.0 mm. The portion 602 between the raised ring and the hollow portion 604 is a lowered or recessed surface, such that, the raised ring 600 comprises the contact surface with the solenoid contact surfaces. The configuration of FIGS. 6a and 6b may be representative of any combination of the contact surfaces 110A and/or 110B and the contact surfaces 103A₁ and/or 103B₁. Additionally, the first raised ring 600 is not required to have a continuously raised portion; that is, the raised ring 600 may have a stepped pattern or other disjointed pattern (i.e., non-contiguous raised portions).

It should be understood by one of ordinary skill in the art that the magnetic forces are typically higher at the outside edges of the spool. This results in a higher “pulling” force of the spool. By moving the raised ring to only the outer portion, there is also a larger surface contact area, compared to only on the inner-more portion. This will result in a greater pulling force, while maintaining the required minimum ratio of the surface area versus boundary line of the surface. An increased surface area at only the inner portion (without any other structures as described herein) results in a same pulling force but may result in the unintended hydraulic latching effects.

The foregoing geometries may be applied to and be representative of any combination of the surfaces 103A₁ and/or 103B₁. Additionally, the geometries may be applied to and be representative of any combination of the solenoid contact surfaces 103A₁ and/or 103B₁ and/or the spool contact surfaces 110A and/or 110B. It is also contemplated by the present invention that the geometries of FIGS. 2-6b can be applied to both of the solenoid contact surfaces 103A₁ and 103B₁ and the contact surfaces 110A and 110B, or any combination thereof. For example, in one aspect, the surface of the solenoid contact surface 103A₁ and the contact surface of the spool 110B has a minimized surface. In aspects of the present invention, a 6.5 mm² surface area vs. 7.6 mm boundary line is contemplated by the present invention resulting in a ratio of about 0.85. In the two ring structure of FIG. 4a, the split ring ratio is, in embodiments, approximately 0.3. In the structure of FIG. 6a, the outside ring has a ratio of about 0.5. The optimal range, for any of the aspects of the present invention, is between 0.2 and 0.5. Other ratios are also contemplated by the present invention. The surface of the spool or solenoid may also include a coating (e.g., diamond like coating (DLC), tungsten carbide/carbon (WC/C), hard chrome and the like). This should improve the wear resistance and thus the robustness. Additional increased hardness and more wear resistant material may also be provided in accordance with the present invention.

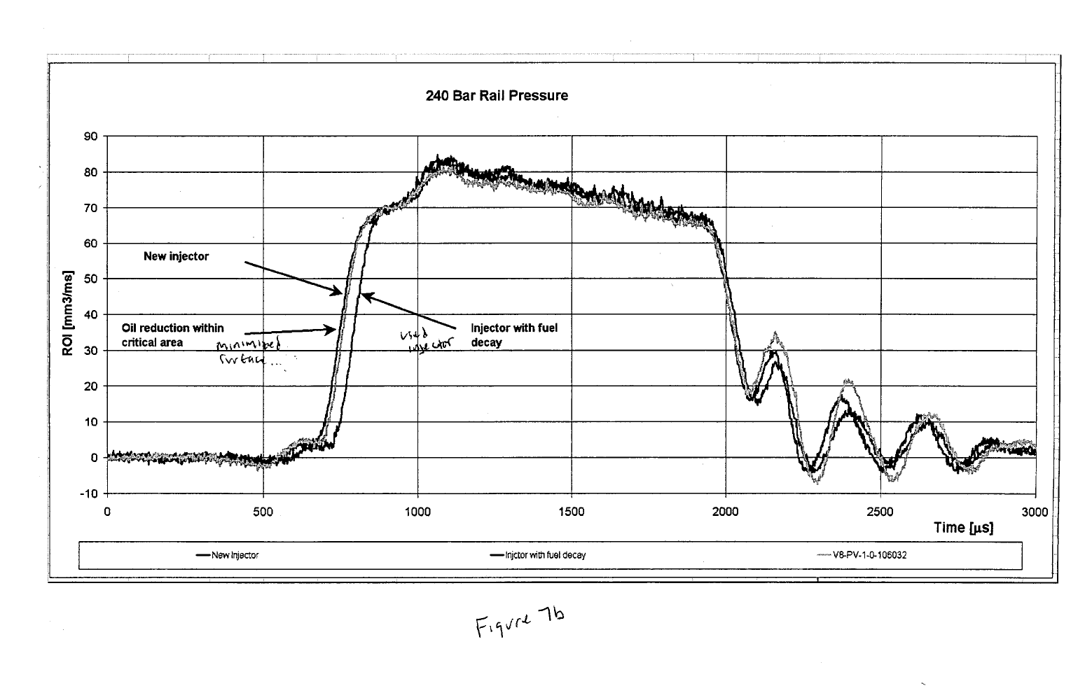

FIGS. 7a and 7b show graphs displaying test results according to embodiments of the present invention. FIGS. 7a and 7b graph rate of injection (ROI) versus time at a rail pressure of 240 bars. The graph of FIG. 7b shows oil reduction in critical areas of the fuel injector of the present invention being substantially the same as that of a new fuel injector. The injector according to the aspects of the present invention has a substantially superior performance over time; whereas, a known injector over time (used injector) shows decreased performance or fuel decay. The fuel decay injectors (e.g., defective injectors) can be restored by applying the minimized surface areas as discussed throughout. After restoration, the reoccurrence of decay is substantially minimized or eliminated.

Operation of the Oil Activated Fuel Injector of the Present Invention

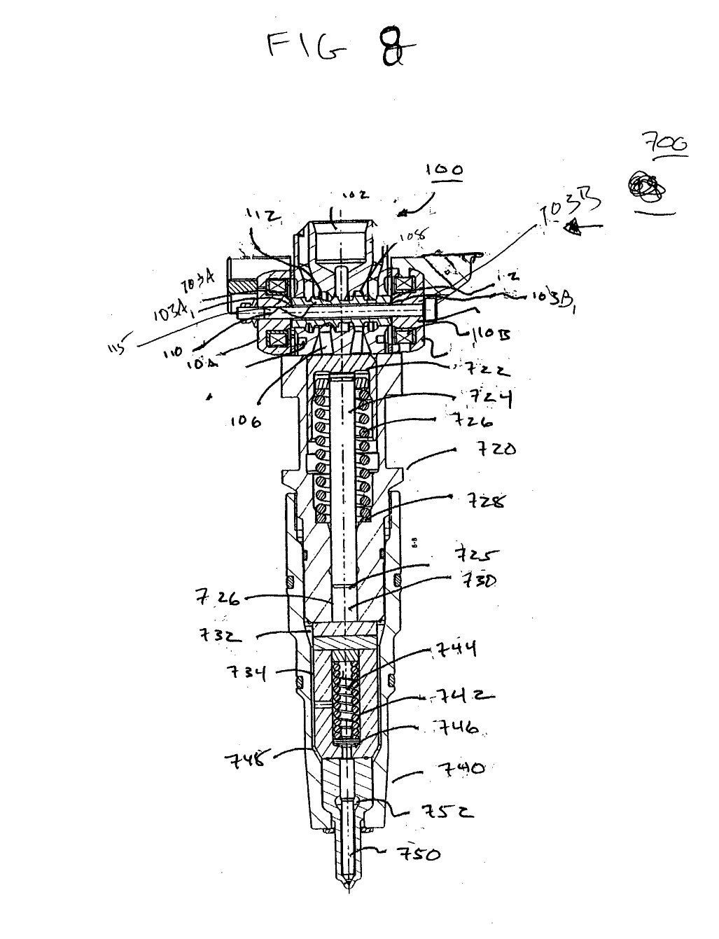

FIG. 8 shows an overall view of the fuel injector assembly 700. The intensifier body 720 is mounted to the valve control body 100 via any conventional mounting mechanism. A piston 722 is slidably positioned within the intensifier body 720 and is in contact with an upper end of a plunger 724. An intensifier spring 726 surrounds a portion (e.g., shaft) of the plunger 724 and is further positioned between the piston 722 and a flange or shoulder 728 formed on an interior portion of the intensifier body 720. The intensifier spring 726 urges the piston 722 and the plunger 724 in a first position proximate to the valve control body 100. In general, a high-pressure chamber 730 is formed by an end portion 725 of the plunger 724 and an interior wall 726 of the intensifier body 720.

The nozzle 740 includes a fuel inlet 732 in fluid communication with the high-pressure chamber 730 and a fuel bore 734. It should be recognized that the fuel bore 734 may be straight or angled or at other known configuration. This fluid communication allows fuel to flow from the high-pressure chamber 730 to the nozzle 740. A spring cage 742, which typically includes a centrally located bore, is bored into the nozzle 740. A spring 744 and a spring seat 746 are positioned within the centrally located bore of the spring cage 742. The nozzle 740 further includes a bore 748 in alignment with the bore 734. A needle 750 is preferably centrally located with the nozzle 740 and is urged downwards by the spring 744. A fuel chamber 752 surrounds the needle 750 and is in fluid communication with the bore 748.

In operation, a driver (not shown) will first energize the coil. The energized coil will then shift the spool 110 to an open position. In the aspects of the present invention, the minimized contact surface areas, for example, the spools contact surfaces 110A and/or 110B and the solenoid contact surfaces 103A₁ and/or 103B₁ substantially prevent any change in the latching effect, particularly hydraulic latching. In the open position, the groove 112 will overlap with the bore and the cross bore (not shown in detail). This provides a fluid path for the working fluid to flow from the inlet port to ambient. In this position, the working fluid pressure within the pressure chamber 730 should be much lower than the rail inlet pressure. At this pressure stage, the spool 110 moves thus sealing the venting space. This will allow the working fluid to flow between the inlet port 102 and the intensifier chamber via the working port 106.

Once the pressurized working fluid is allowed to flow into the working port 106 it begins to act on the piston and the plunger. That is, the pressurized working fluid will begin to push the piston and the plunger downwards thus compressing the intensifier spring. As the piston is pushed downward, fuel in the high-pressure chamber will begin to be compressed via the end portion of the plunger. A quantity of compressed fuel will be forced through the bores into the heart chamber which surrounds the needle. As the pressure increases, the fuel pressure will rise above a needle check valve opening pressure until the needle spring is urged upwards. At this stage, the injection holes are open in the nozzle thus allowing a main fuel quantity to be injected into the combustion chamber of the engine.

To end the injection cycle, the driver will energize the closed coil. The magnetic force generated in the coil will then shift the spool 110 into the closed position, which, in turn, will offset the groove from the cross bore. The change in the latching effect may also be minimized or eliminated at this stage due to a minimized surface area. At this stage, the pressure will begin to increase in the pressure chamber and force the spool 110 in the direction of arrow. This will open the venting space between the flat body area and the leading edge of the spool 110. Also, the inlet port 102 will no longer be in fluid communication with the bore 114 (and intensifier chamber). The working fluid within the intensifier chamber will then be vented to ambient and the needle spring will urge the needle downward towards the injection holes of the nozzle thereby closing the injection holes. Similarly, the intensifier spring will urge the plunger and the piston into the closed or first position adjacent to the valve. As the plunger moves upward, fuel will again begin to flow into the high-pressure chamber of the intensifier body.

While the invention has been described in terms of preferred embodiments, those skilled in the art will recognize that the invention can be practiced with modification within the spirit and scope of the appended claims.

It is claimed:

1. A hydraulically controlled valve control body, comprising:
a control body;
a first solenoid coil positioned at a first end of the control body;
a second solenoid coil positioned at an opposing second end of the control body;
a spool positioned within the control body between the first and second solenoid coils; and
a minimized contact surface area contacting the spool and one of the first and second solenoid coils to prevent a change in latching effects.

2. The hydraulically controlled valve control body of claim 1, wherein the minimized contact surface area is a raised portion including a substantially hatched portion.

3. The hydraulically controlled valve control body of claim 2, wherein the substantially hatched portion includes at least one of a substantially star pattern, helical pattern, and a crossed hatched pattern.

4. The hydraulically controlled valve control body of claim 2, wherein the hatched portion includes recessed portions acting as oil drains to minimize an oil film between the spool and one of the first and second solenoid coils.

5. The hydraulically controlled valve control body of claim 1, wherein the minimized contact surface area is a first substantially raised ring portion having a first diameter.

6. The hydraulically controlled valve control body of claim 5, wherein the first substantially raised ring portion includes non-contiguous raised portions.

7. The hydraulically controlled valve control body of claim 5, wherein the first substantially raised ring portion is about substantially an outer diameter of one of the ends of the spool or the first or second solenoid coils.

8. The hydraulically controlled valve control body of claim 5, further including a second substantially raised ring portion having a second diameter.

9. The hydraulically controlled valve control body of claim 1, wherein the minimized contact surface area is a first raised projection having a substantially rectangular shape.

10. The hydraulically controlled valve control body of claim 9, wherein the minimized contact surface area is a second raised projection having a substantially rectangular shape separated from the first raised projection.

11. The hydraulically controlled valve control body of claim 1, wherein the minimized contact surface area includes a chamfered region.

12. The hydraulically controlled valve control body of claim 11, wherein the chamfered region is formed on one of an inside portion of a contact surface and an outside portion of the contact surface.

13. The hydraulically controlled valve control body of claim 1, wherein the minimized contact surface area is a raised portion formed on a first end portion of the spool.

14. The hydraulically controlled valve control body of claim 1, wherein the minimized contact surface area is a raised portion formed on first and second end portions of the spool.

15. The hydraulically controlled valve control body of claim 1, wherein the minimized contact surface area is a raised portion formed on a facing portion of the first solenoid coil.

16. The hydraulically controlled valve control body of claim 1, wherein the minimized contact surface area is a raised portion formed on facing portions of the first and second solenoid coils.

17. The hydraulically controlled valve control body of claim 1, wherein the minimized contact surface area is a raised portion formed on an end portion of the spool and another raised portion formed on an end portion of the first solenoid coil.

18. The hydraulically controlled valve control body of claim 1, wherein the minimized contact surface area provides a minimized ratio of surface area versus boundary line of a contact surface

19. The hydraulically controlled valve control body of claim 1, wherein the minimized contact surface area provides drainage of an oil film between the spool and one of the first or second solenoid coils.

20. A replacement kit for a hydraulically controlled valve control body, comprising:
one of a spool and an end cap having a minimized contact surface area such that a reassembled valve control body includes the minimized surface area positioned between the spool and the end cap for reducing a change in latching effects between the spool and the end caps thereby minimizing spool delay.

21. A fuel injector, comprising:
a body control valve having an inlet port and working ports;
a first and second solenoid coil positioned at opposing ends of the body control valve;
a slidably mounted spool arranged substantially between the first and second solenoid coils;
a minimized contact surface area between the spool and one of the first and second solenoid coils to prevent a change in latching between the spool and one of the first and second solenoid coil;
an intensifier chamber having a piston and plunger assembly, the intensifier chamber being in fluid communication with the working ports;
a high pressure fuel chamber arranged below a portion of the plunger; and
a needle chamber having a needle responsive to an increased fuel pressure created in the high pressure fuel chamber.

22. The fuel injector of claim 21, wherein the minimized contact surface area is on one of the spool or facing ends of either or both first and second solenoid coil.

23. The fuel injector of claim 21, wherein the minimized contact surface area provides a minimized ratio of surface area versus boundary line of a contact surface.

24. A valve control body, comprising:
a control body;
a first solenoid coil positioned at a first end of the control body;
a second solenoid coil positioned at an opposing second end of the control body;
a spool positioned within the control body between the open and closed solenoid coils; and
means for prevent a change in latching effects between a contact surface area between the spool and one of the first and second solenoid coils.

25. The valve control body of claim 24, wherein the preventing means is a roughened surface.

26. The valve control body of claim 24, further comprising a surface coating on at least one of the spool and one of the first and second solenoids.

27. The valve control body of claim 24, further comprising an increased hardness of a surface of at least one of the spool and one of the first and second solenoids.
